(19) United States
(12) Patent Application Publication
(10) Pub. No.: US 2003/0104869 A1
(43) Pub. Date: Jun. 5, 2003

(54) Gaming apparatus

(76) Inventor: Anthony Dennis Boulton, Surrey (GB)

Correspondence Address: SMITH-HILL AND BEDELL, 12670 N W BARNES ROAD, SUITE 104, PORTLAND, OR, 97229

(21) Appl. No.: 10/310,472

(22) Filed: Dec. 4, 2002

(30) Foreign Application Priority Data
Dec. 4, 2001 (GB) 0128937.0

(51) Int. Cl. A63F 9/24; A63F 13/00; G06F 17/00; G06F 19/00

(52) U.S. Cl. 463/42

(57) ABSTRACT

Gaming apparatus is disclosed which comprises a plurality of first play means in the form of gaming stations (12) operable to provide independent play by respective users. The apparatus also comprises second play means (14) connected to the gaming station. The second play means provides for further play by user of any of the gaming stations (12).

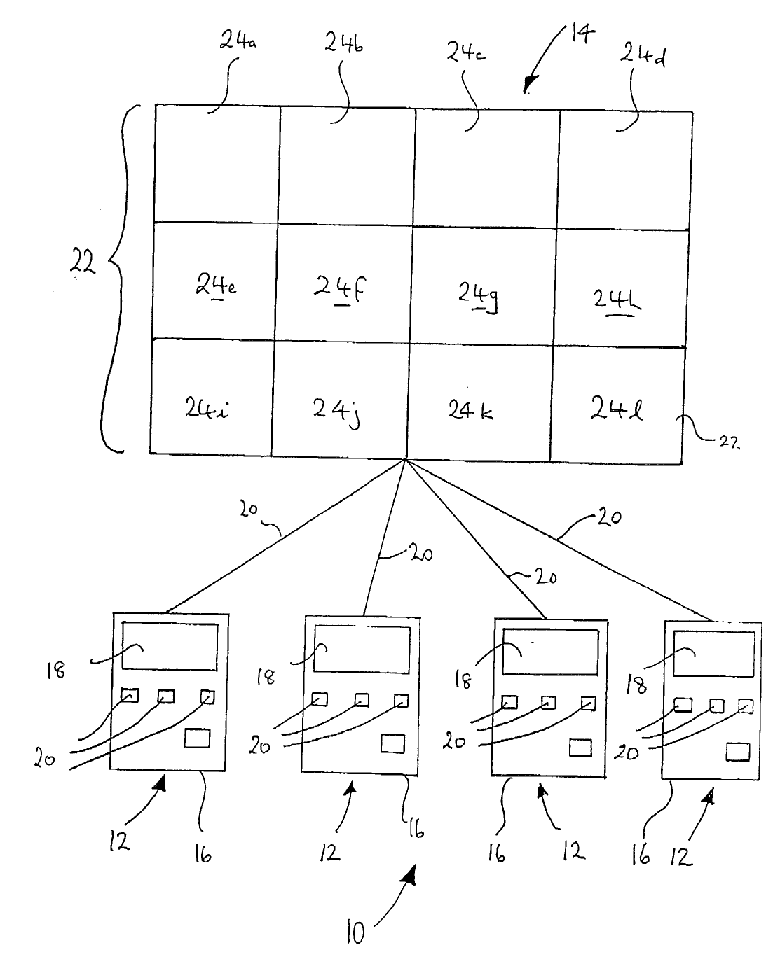

### FIELD OF THE INVENTION

The present invention relates to gaming apparatus.

Gaming apparatus for playing games, for example, in arcades are known. However, such gaming apparatus provide little or no involvement for people other than the person playing the game.

### SUMMARY OF THE INVENTION

According to the present invention there is provided gaming apparatus comprising a plurality of first play means operable to provide independent play by respective users, and second play means connected to said first play means to provide for further play by a user of any of said first play means.

Preferably the second play means is viewable for play by each respective user of the first play means. The first play means may comprise display means operable to show said play by the respective user. The second play means may comprise second display means operable to show the further play during use.

According to a further aspect of this invention there is provided gaming apparatus comprising a plurality of first play means, at each of which a respective user can play independently of the, or each, other first play means, and second play means comprising display means operatively associated with each of said first play means and viewable by a user at each of said first play means, wherein the play by a user of said first play means is displayed on said display means.

Preferably, the first play means comprises first display means and the second play means comprises second display means.

According to another aspect of this invention there is provided gaming apparatus comprising a plurality of first play means each having a respective first display means, at each of which first play means a respective user can play independently of the, or each, other first play means, and second play means comprising second display means operatively associated with each of said first play means and viewable by a user at each of said first play means, wherein a user of one of said first play means can engage a further play at the respective first play means, said further play being displayed on said second display means.

Preferably, each of said first play means comprises a gaming station.

Preferably the first play means provide for play at a first level, and second play means for play at a second level. Preferably, the second play means is playable by a user when a predetermined event occurs on the respective first play means.

The second display means may be larger than the first mentioned display means and may comprise a screen, which may include an array of smaller screens.

Preferably the first play means provide a first level of play which is of generally known type, such as reel-based gaming, which may include reel-based gambling.

The second play means may be operable to provide a second level of play which is controlled by a user of one of the first play means using control means provided on the first play means. The second level of play may comprise a gambling facility.

Preferably, each first play means comprise means to activate the second play means for further play when a pre-determined event occurs during play at the first level on the first play means, which event may be a pre-determined win or bonus event.

Preferably, the second display means is separate physically from each of the first play means, but may be connected to said first play means electrically, for example by electrical cables.

According to a further aspect of the present invention there is provided further play means connectable to a plurality of gaming stations to provide for further play by a user of any of said gaming stations.

The further play means may be as hereinbefore described in any of the preceding paragraphs.

### DESCRIPTION OF THE DRAWINGS

A preferred embodiment of the present invention will now be described by way of example only with reference to the accompanying drawing, which is a diagrammatic illustration of gaming apparatus according to the present invention.

### DESCRIPTION OF THE PREFERRED EMBODIMENT

Referring to the drawings there is provided gaming apparatus 10 comprising a plurality of gaming stations 12 operable to provide independent play by respective users (not shown), and further play means 14 connected to said gaming stations 12 to provide for further play by a user of any of said gaming stations 12.

In more detail, four gaming stations 12 are illustrated, although it will be appreciated that any number within a plurality of gaming stations may be provided in accordance with the present invention.

Each gaming station 12 comprises a body 16 having a screen 18 and controls 20.

Each gaming station 12 may be of any suitable generally conventional design insofar as they each provide for independent play by a respective user thereon, at a first level.

The gaming stations 12 in this embodiment are in the form of a generally conventional reel-based gaming machines, such as fruit machines or derivatives thereof. It is however within the scope of the present invention that the nature of the play provided at the first level can be of any suitable type.

Each gaming station 12 is connected to the further play means 40, and the connections are shown diagrammatically at 20 in the drawing. It will be appreciated that any suitable means of connection can be employed, such as cable or indeed radiation transmission.

It is also shown that each gaming station 12 is connected directly to the further play means 14, although the gaming stations may be connected together with one or more connections between the plurality of stations 12 and one or more connections with the further play means 14.

The further play means 14 comprises a relatively large display 22 made up of an arrangement of 12 screen 24a-l. The screens 24a-l may be conventional cathode-ray or flat screens. The further play means 14 also comprises control means (not shown) to control the respective displays on the screens during said further play at the second level. Alternatively, the display 22 may comprise a single screen split into a plurality of segments.

The nature of play at the second level may be of any suitable type. One particular type is to have pre-determined win values allocated to each of the screens 24a-l. The screens 24a-l, in random order and one at a time briefly display the amount of the win. During play, a user at one of the stations 12 activates one of the controls 20 to freeze the display and the screen that is displayed will determine the amount of win a user has secured.

The further play means 14 and gaming station 12 communicate via the connection 20 and data is relayed between the gaming stations 12 and further play means 14.

In use, the gaming stations 12 are played by respective users at the first level of play. A user will insert tokens or credits into the stations 12 and play on the gaming stations 12 at the first level, until a pre-determined event occurs. That event may be a first-level win or a bonus event.

When such an event occurs, the gaming station 12 on which it occurs activates the further play means 14 via the connection 20 to provide for further play by the user of that station 12 at a second level on the further play means 14.

The user of the station 12 plays on the further play means at the second level. During play data is transmitted between the further play means 14 and the gaming station 12. Should the user achieve a win on the further play means 14 an appropriate signal is transmitted from the further play means 14 to the gaming station 12 played by the user, which processes the information and takes the necessary action, which may include dispensing of a win to a user, or possibly further activation for play of the station 12. The win dispensed to the user may be coins or tokens or maybe prizes in the form of gifts or, e.g. holidays.

The provision of the further play means 14, which can be viewed by each of the users on the respective stations 12 provides for an interesting further dimension to the gaming provided by the stations 12. It also adds further interest insofar as a user playing at the second level on the further play means 14 does so visibly in front of all the other users of the gaming stations 12 which gives that user kudos, and adds further incentive to the users of the other stations 12 to achieve an appropriate event on their respective stations 12 so that they can play on the further play means 14. In addition, the further play means 14 is visible to other people who may be attracted to play on the gaming stations 12.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. Gaming apparatus comprising a plurality of first play means operable to provide independent play by respective users, and second play means connected to said first play means to provide for further play by a user of any of said first play means.

2. Gaming apparatus according to claim 1, wherein each of first play means comprises a gaming station.

3. Gaming apparatus according to claim 1, wherein the first play means provides for playing at a first level and the second play means for play at a second level.

4. Gaming apparatus according to claim 3, wherein the second play means is playable by a user when a predetermined event occurs on the respective first play means.

5. Gaming apparatus according to claim 1, wherein the second play means is viewable for play by a prospective user of the first play means, the first play means comprising first display means operable to show said play by the respective user, and the second play means comprising second display means operable to show the further play during use.

6. Gaming apparatus according to claim 5, wherein the second display means is physically separate from each of the first play means.

7. Gaming apparatus according to claim 5, wherein the second display is larger than the first display and comprises a screen.

8. Gaming apparatus according to claim 7, wherein the screen comprises an array of smaller screens.

9. Gaming apparatus according to any preceding claim wherein the first play means provides a first level of play which comprises reel based gaming.

10. Gaming apparatus according to claim 9, wherein the reel based gaming comprises reel based gambling.

11. Gaming apparatus according to claim 1, wherein the first claim means comprises control means to control play on the first play means, and the second play means is operable to provide a level of play which is controlled by the control means on one of the first play means.

12. Gaming apparatus according to claim 8, wherein the second level of play comprises a gambling facility.

13. Gaming apparatus according to claim 1, wherein each first play means comprises means to activate the second play means for further play when a predetermined event occurs during play at the first level on the first play means.

14. Gaming apparatus according to claim 10 wherein said event is a predetermined win or bonus event.

15. Gaming apparatus comprising a plurality of first play means, at each of which a respective user can play independently of the, or each, other first play means, and second play means comprising display means operatively associated with each of said first play means and viewable by a user at each of said first play means, wherein the play by a user of said first play means is displayed on said display means.

16. Gaming apparatus comprising a plurality of first play means, each having a respective first display means, at each of which first play means a respective user can play independently of the, or each, other first play means, said play being displayed respectively on each first play means, and second play means comprising second display means operatively associated with each of said first play means and viewable by a user at each of said first play means, wherein a user of one of said first play means can engage in further play at the respective first play means, said further play being displayed on said second display means.
